(19) United States
(12) Patent Application Publication
(10) Pub. No.: US 2023/0303016 A1
(43) Pub. Date: Sep. 28, 2023

(54) WIRE HARNESS UNIT

(71) Applicant: SUMITOMO WIRING SYSTEMS, LTD., Yokkaichi-shi, Mie (JP)

(72) Inventor: Takeo MARUCHI, Yokkaichi-shi (JP)

(73) Assignee: SUMITOMO WIRING SYSTEMS, LTD., Yokkaichi-shi, Mie (JP)

(21) Appl. No.: 18/020,359

(22) PCT Filed: Aug. 4, 2021
(86) PCT No.: PCT/JP2021/028870

§ 371 Date: Feb. 8, 2023

(30) Foreign Application Priority Data
Aug. 26, 2020 (JP) 2020-142640

(51) Int. Cl. B60R 16/02; H02G 3/03; H02G 3/04

(52) U.S. Cl. CPC B60R 16/0215; H02G 3/03; H02G 3/04

(57) ABSTRACT

A wire harness unit including: a plurality of conductive paths; and a cooling tube through which a coolant is able to flow for cooling the plurality of conductive paths, wherein: the plurality of conductive paths include a first conductive path and a second conductive path parallel with the first conductive path, the first conductive path includes a first tubular conductor that is conductive and hollow, the second conductive path includes a second tubular conductor that is conductive and hollow, the cooling tube is separate from the first tubular conductor and the second tubular conductor, the first tubular conductor and the second tubular conductor are more rigid than the cooling tube, and the cooling tube includes a first section extending through the first tubular conductor, a second section extending through the second tubular conductor, and a turnback portion that links the first section and the second section.

### BACKGROUND

The present disclosure relates to a wire harness unit.

Conventionally, wire harnesses installed in vehicles such as hybrid cars and electric cars electrically connect a plurality of electrical devices to each other. Also, in electric cars, vehicles and ground facilities are connected to each other by a wire harness, and a power storage device installed in the vehicle is charged by the ground facility. As a result of a voltage supplied through the wire harness being high, the amount of heat generated by the wire harness is increased. For this reason, configurations for cooling wire harnesses have been proposed.

For example, JP 2019-115253A discloses a wire harness provided with a coated wire, an inner tube that covers the coated wire, and an outer tube that covers the inner tube with a predetermined space therebetween, in which a circulation path for a coolant is formed between the inner tube and the outer tube. The circulation path is formed by inner and outer tubes that are separate from the coated wire, and the coated wire is disposed radially inward of the circulation path.

### SUMMARY

Incidentally, in the wire harness disclosed in JP 2019-115253A, the circulation path (a path along which the coolant flows) is disposed outside the coated wire, and thus the coolant is far from the central portion of the coated wire, which is the heat source. Accordingly, there is room for improvement in terms of cooling efficiency of the coated wire.

An exemplary aspect of the disclosure provides a wire harness unit capable of improving cooling efficiency.

A wire harness unit that is an aspect of the present disclosure includes a plurality of conductive paths for conducting electricity between in-vehicle devices; and a cooling tube through which a coolant is able to flow for cooling the plurality of conductive paths, wherein: the plurality of conductive paths include a first conductive path and a second conductive path parallel with the first conductive path, the first conductive path includes a first tubular conductor that is conductive and hollow, the second conductive path includes a second tubular conductor that is conductive and hollow, the cooling tube is separate from the first tubular conductor and the second tubular conductor, the first tubular conductor and the second tubular conductor are more rigid than the cooling tube, and the cooling tube includes a first section extending through the first tubular conductor, a second section extending through the second tubular conductor, and a turnback portion that links the first section and the second section.

According to a wire harness unit that is an aspect of the present disclosure, cooling efficiency can be improved.

### BRIEF DESCRIPTION OF THE DRAWINGS

FIG. 1 is a schematic diagram showing a vehicle in which a wire harness unit according to an embodiment is routed.

FIG. 2 is a schematic diagram of the wire harness unit.

FIG. 3 is a partial cross sectional view showing an overview of the wire harness unit.

FIG. 4 is a cross sectional view of the wire harness unit.

FIG. 5 is a diagram illustrating connection between a tubular conductor, a flexible conductor, and a terminal.

FIG. 6 is a schematic diagram showing a portion of the wire harness unit.

### DETAILED DESCRIPTION OF EMBODIMENTS

### Description of Embodiments of Disclosure

First, aspects of the present disclosure will be listed and described.

[1] A wire harness unit according to the present includes a plurality of conductive paths for conducting electricity between in-vehicle devices, and a cooling portion for cooling the plurality of conductive paths, the plurality of conductive paths include a first conductive path and a second conductive path that is parallel with the first conductive path, the first conductive path includes a first tubular conductor that is conductive and hollow, the second conductive path includes a second tubular conductor that is conductive and hollow, the cooling portion includes a cooling tube through which a coolant is able to flow and that is separate from the first tubular conductor and the second tubular conductor, the first tubular conductor and the second tubular conductor are more rigid than the cooling tube, and the cooling tube includes a first section extending through the first tubular conductor, a second section extending through the second tubular conductor, and a turnback portion that links the first section and the second section.

According to this configuration, as a result of the first section of the cooling tube extending through the first tubular conductor, and the second section extending through the second tubular conductor, the coolant can flow inside the first tubular conductor and the second tubular conductor. For this reason, the first tubular conductor and the second tubular conductor can be cooled from the inside, thereby making it possible to improve cooling efficiency. Moreover, since the cooling tube includes the turnback portion that links the first section and the second section, it is possible to reduce the number of inlets and outlets for the coolant, and simplify the structure for connection to a pump, for example, compared with a case where the cooling tube does not include the turnback portion and a cooling tube is provided for each conductive path. In addition, for example, it is possible to reduce the number of cooling tubes and the number of components compared with a case where the cooling tube does not include the turnback portion and a cooling tube is provided for each conductive path.

[2] It is preferable that the number of conductive paths included in the plurality of conductive paths is an even number.

According to this configuration, since the number of conductive paths included in the plurality of conductive paths is an even number, the inlet and the outlet for the coolant can be easily positioned close to each other. That is to say, a situation is avoided where the positions of the inlet and the outlet for the coolant are spaced far apart from each other when, for example, the number of conductive paths is three, which is an odd number, and the cooling tube further includes a third section extending through a third tubular conductor of a third conductive path, and a turnback portion that links the second section and the third section. Thus, it is possible to easily set the positions of the inlet and the outlet for the coolant close to each other, and to reduce a routing space and the like for connection to a pump, for example.

[3] It is preferable that the wire harness unit further includes an exterior member for covering the conductive paths, the exterior member includes a tubular exterior member and a grommet that is connected to an end portion of the tubular exterior member, and the turnback portion is disposed inside the grommet.

According to this configuration, since the turnback portion is disposed inside the grommet, it is possible to easily house the turnback portion, for example. Even in a case where, for example, the turnback portion is configured such that it cannot be sharply bent, and a large space is required, such a case can be easily addressed without increasing the entire size of the tubular exterior member. Moreover, for example, if the grommet is shaped such that the size thereof increases toward a member that is connected to the grommet, the turnback portion can be easily housed in a large space.

[4] It is preferable that an outer circumferential surface of the cooling tube is in contact with an inner circumferential surface of the first tubular conductor and an inner circumferential surface of the second tubular conductor.

According to this configuration, since the outer circumferential surface of the cooling tube through which the coolant flows is in contact with the inner circumferential surface of the first tubular conductor and the inner circumferential surface of the second tubular conductor, it is possible to further cool the first tubular conductor and the second tubular conductor.

[5] It is preferable that the first conductive path and the second conductive path each include a flexible conductor and a terminal, the flexible conductor includes a first end portion that is electrically connected to the first tubular conductor or the second tubular conductor, and a second end portion that is electrically connected to the terminal, and the flexible conductor is more flexible than the first tubular conductor and the second tubular conductor.

According to this configuration, due to end portions of the first tubular conductor and the second tubular conductor being connected to the flexible conductors, dimensional tolerance of the conductive paths can be absorbed. Further, this configuration is a counter measure against swinging generated while a vehicle is travelling.

[6] It is preferable that each of the first tubular conductor and the second tubular conductor is longer than the flexible conductor.

According to this configuration, since each of the first tubular conductor and the second tubular conductor is longer than the flexible conductor, the sections where the first tubular conductor and the second tubular conductor are in contact with the cooling tube are long, and the first tubular conductor and the second tubular conductor can be further cooled.

[7] It is preferable that the wire harness unit further includes an electromagnetic shield member for covering at least a portion of the cooling tube, the first tubular conductor, and the second tubular conductor, the electromagnetic shield member is a braided member formed by braiding metal strands, and the portion of the cooling tube extends through the braided member.

According to this configuration, both the shielding properties for suppressing electromagnetic noise radiation from the conductive paths and an improvement in the ease of assembly of the cooling portion can be achieved.

[8] It is preferable that the wire harness unit further includes an exterior member for covering the conductive paths, and the exterior member includes a tubular exterior member and a grommet connected to an end portion of the tubular exterior member, and the cooling tube extends through the grommet.

According to this configuration, since the cooling tube extends through the grommet and is led out to the outside, a decrease in the water blocking properties of the wire harness unit can be suppressed.

### Description of Embodiments of Disclosure

Specific examples of a wire harness unit according to the present disclosure will be described below with reference to the drawings. Note that in the drawings, parts of the configurations may be shown in an exaggerated or simplified manner for convenience of description. Moreover, dimensional ratios of various portions may be different from actual dimensional ratios. “Parallel” and “orthogonal” in the present specification include not only being exactly parallel and orthogonal but also approximately parallel and orthogonal within a range in which the operation and effects of the present embodiment can be achieved. The present disclosure is not limited to the embodiments disclosed herein, but is defined by the claims, and intended to include all modifications within the meaning and the scope equivalent thereof.

### Overview Configuration of Wire Harness Unit 10

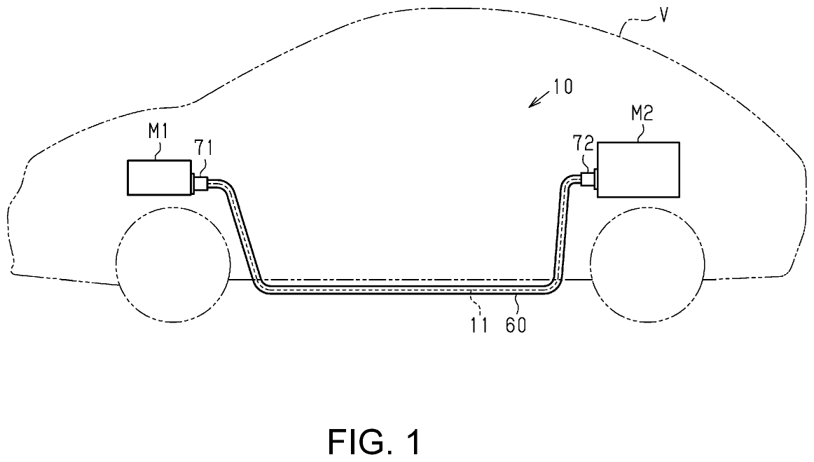

A wire harness unit 10 shown in FIG. 1 electrically connects two in-vehicle devices installed in a vehicle V. The vehicle V is, for example, a hybrid car, an electric car, or the like. The wire harness unit 10 includes conductive paths 11 for electrically connecting an in-vehicle device M1 and an in-vehicle device M2, and an exterior member 60 (exterior cover) for covering the conductive paths 11. The conductive paths 11 are routed, for example, from the in-vehicle device M1 to the in-vehicle device M2 so that portions thereof in a lengthwise direction pass under the floor of the vehicle V. With regard to examples of the in-vehicle device M1 and the in-vehicle device M2, the in-vehicle device M1 is an inverter installed toward the front side of the vehicle V, and the in-vehicle device M2 is a high-voltage battery installed on the rear side of the vehicle V relative to the in-vehicle device M1. The in-vehicle device M1 serving as an inverter is connected to a motor (not shown) for driving the wheels serving as a motive power source for causing the vehicle to travel, for example. The inverter generates AC power from DC power from the high-voltage battery, and supplies the AC power to the motor. The in-vehicle device M2, which is a high-voltage battery, is a battery capable of supplying a voltage of at least 100 V, for example. In other words, the conductive paths 11 of the present embodiment constitute a high-voltage circuit that enables high-voltage exchange between the high-voltage battery and the inverter.

### Detailed Configuration of Wire Harness Unit 10

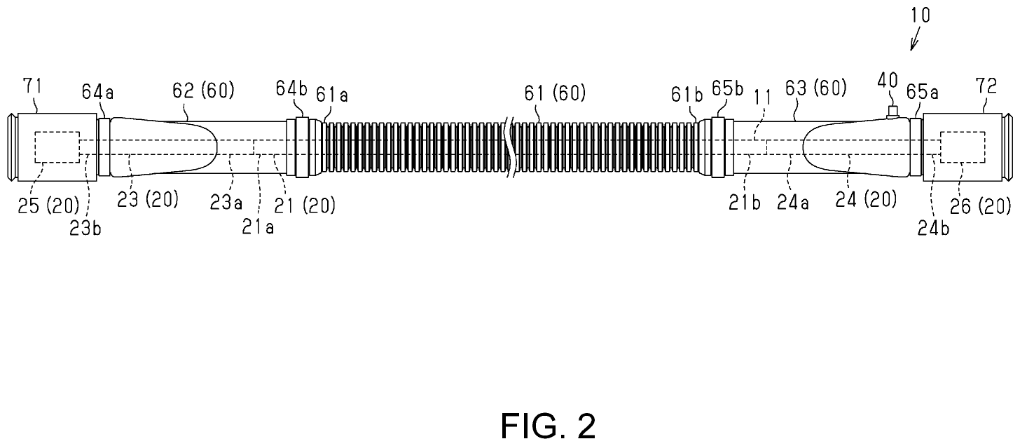

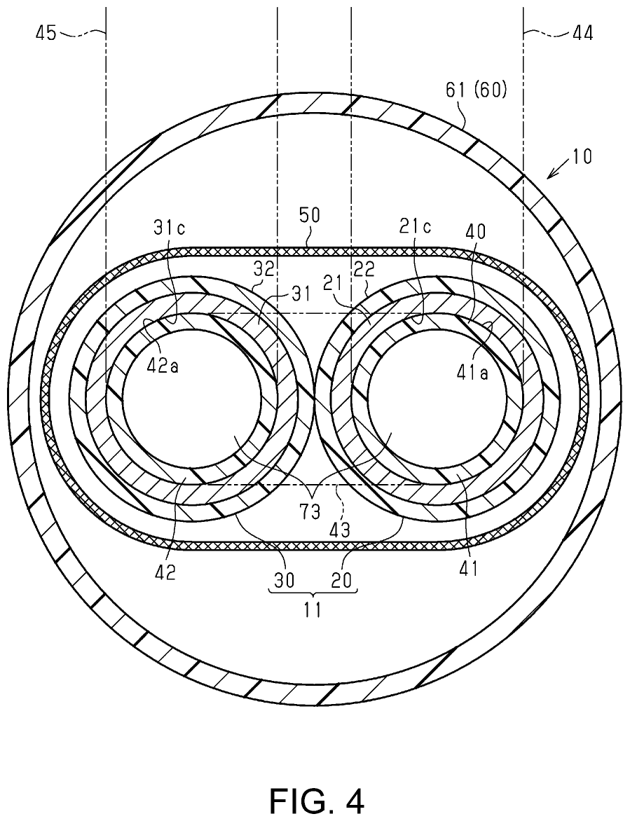

As shown in FIGS. 2, 3, and 4, the wire harness unit 10 includes a plurality of conductive paths 11, a cooling tube 40, an electromagnetic shield member 50 (electromagnetic shield), an exterior member 60, and connectors 71 and 72. As shown in FIGS. 4 and 6, the plurality of conductive paths 11 include a first conductive path 20 and a second conductive path 30 that is parallel with the first conductive path 20.

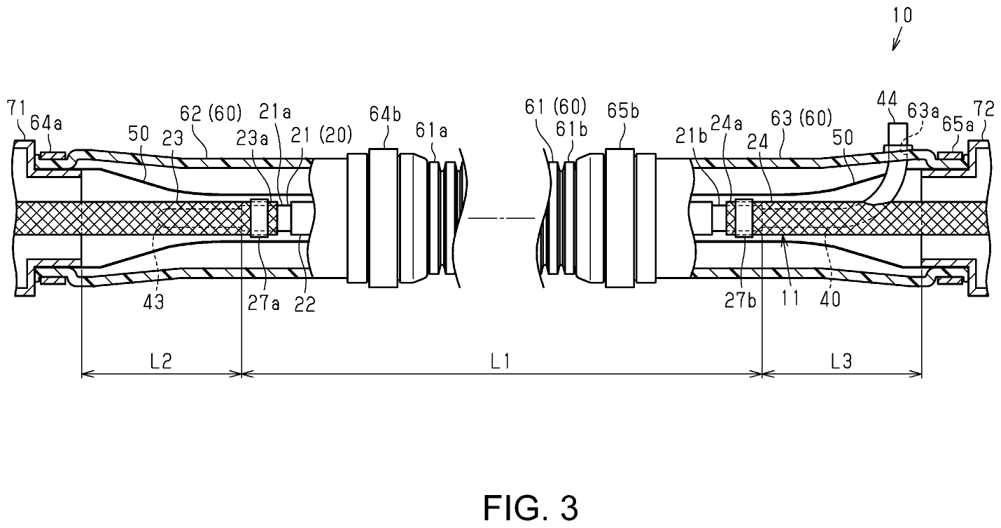

As shown in FIGS. 3 to 6, the first conductive path 20 includes a first tubular conductor 21, an insulating coating 22, flexible conductors 23 and 24, and terminals 25 and 26.

The first tubular conductor 21 is conductive and has a hollow structure. The first tubular conductor 21 is made of metal, for example, and has high shape retaining properties. In other words, the first tubular conductor 21 can retain its shape. The material for the first tubular conductor 21 is a metal material such as a copper-based material or an aluminum-based material. The first tubular conductor 21 is formed in a shape conforming to a routing path of the wire harness unit 10 shown in FIG. 1. The first tubular conductor 21 is bent using a pipe bender (in other words, a pipe bending device).

FIG. 4 is a cross-sectional view of the wire harness unit 10 taken along a plane orthogonal to the lengthwise direction of the wire harness unit 10. In FIG. 4, the lengthwise direction of the first tubular conductor 21 is the front-back direction of the sheet plane of FIG. 4. The cross-sectional shape of the first tubular conductor 21 taken along a plane that is vertical to the lengthwise direction of the first tubular conductor 21, that is, a direction in which the first tubular conductor 21 extends and that is the axial direction of the first tubular conductor 21 (i.e., a lateral cross-sectional shape) is annular, for example. Note that, the cross sectional shape of the first tubular conductor 21 can be any shape. Also, with respect to the cross sectional shape of the first tubular conductor 21, the shapes of the outer circumference and the inner circumference may be different from each other. Also, cross sectional shapes of the first tubular conductor 21 in the lengthwise direction may be different from each other.

The insulating coating 22 covers the entirety of the outer circumferential surface of the first tubular conductor 21 in the circumferential direction, for example. The insulating coating 22 is constituted by an insulating material such as a synthetic resin. Examples of the material for the insulating coating 22 include silicone resin, a synthetic resin whose main component is a polyolefin resin such as cross-linked polyethylene or cross-linked polypropylene, and the like. A single kind of material, or two or more kinds of materials can be used in combination as appropriate, for the insulating coating 22. The insulating coating 22 can be formed by performing extrusion molding (extrusion coating) on the first tubular conductor 21, for example.

As shown in FIG. 3, the first tubular conductor 21 includes a first end portion 21a and a second end portion 21b that are two end portions of the first tubular conductor 21 in the lengthwise direction. The first end portion 21a and the second end portion 21b are exposed from the insulating coating 22.

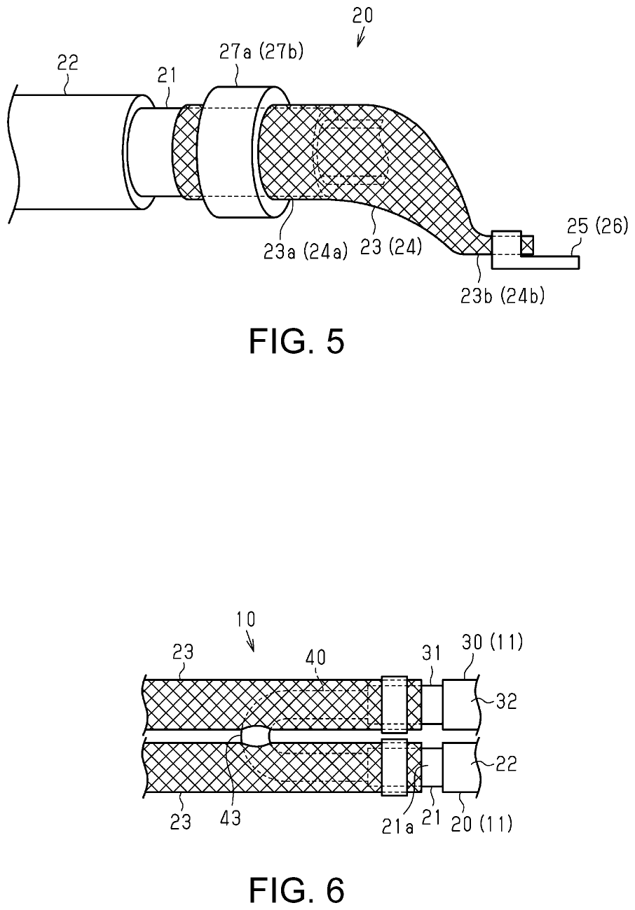

As shown in FIGS. 3 and 5, end portions on one side of the flexible conductors 23 and 24 are respectively connected to the first end portion 21a and the second end portion 21b, and end portions on the other side of the flexible conductors 23 and 24 are respectively connected to the terminals 25 and 26 shown in FIG. 2. Specifically, the flexible conductor 23 includes a first end portion 23a that is electrically connected to the first end portion 21a of the first tubular conductor 21 and a second end portion 23b that is electrically connected to the terminal 25 shown in FIGS. 2 and 5. The flexible conductor 24 includes a first end portion 24a that is electrically connected to the second end portion 21b of the first tubular conductor 21 and a second end portion 24b that is electrically connected to the terminal 26 shown in FIG. 2.

The flexible conductors 23 and 24 are conductors that are more flexible than the first tubular conductor 21. The flexible conductors 23 and 24 of the present embodiment are formed in a tubular shape. The flexible conductors 23 and 24 are braided wires formed by braiding conductive wire strands into a tubular shape. The material for the wire strands is a metal material such as a copper-based material or an aluminum-based material.

As shown in FIG. 3, the first end portion 21a of the first tubular conductor 21 is disposed inside the tubular first end portion 23a of the flexible conductor 23. In other words, the first end portion 23a of the tubular flexible conductor 23 covers the first end portion 21a of the first tubular conductor 21. A fastening band 27a is attached to the outer circumference side of the flexible conductor 23. The flexible conductor 23 is crimped to the outer circumferential surface of the first tubular conductor 21 by the fastening band 27a. The first end portion 23a of the flexible conductor 23 is electrically connected to the outer circumferential surface of the first end portion 21a of the first tubular conductor 21 using the fastening band 27a. Note that the first tubular conductor 21 and the flexible conductor 23 may also be connected to each other through welding such as ultrasonic welding.

The second end portion 21b of the first tubular conductor 21 is disposed inside the tubular first end portion 24a of the flexible conductor 24. In other words, the first end portion 24a of the tubular flexible conductor 24 covers the second end portion 21b of the first tubular conductor 21. A fastening band 27b is attached to the outer circumference side of the flexible conductor 24. The flexible conductor 24 is crimped to the outer circumferential surface of the first tubular conductor 21 using the fastening band 27b. The first end portion 24a of the flexible conductor 24 is electrically connected to the outer circumferential surface of the second end portion 21b of the first tubular conductor 21 by the fastening band 27b. Note that the flexible conductor 24 and the first tubular conductor 21 may be connected to each other through welding such as ultrasonic welding.

FIG. 5 is an illustrative diagram showing connection between the first tubular conductor, the flexible conductors, and the terminals. Note that, in FIG. 5, the members of the first conductive path 20 shown on the left side of FIGS. 2 and 3 are indicated by reference signs without parentheses, and the members shown on the right side of FIGS. 2 and 3 are indicated by reference signs in parentheses.

The terminal 25 is held by the connector 71 shown in FIGS. 1 and 2, and connected to the in-vehicle device M1. The terminal 25 is connected to the second end portion 23b of the flexible conductor 23. For example, the terminal 25 includes a pair of crimping pieces, with which the terminal 25 is crimped to the second end portion 23b of the flexible conductor 23. The terminal 26 is held by the connector 72 shown in FIGS. 1 and 2, and connected to the in-vehicle device M2. The terminal 26 is connected to the second end portion 24b of the flexible conductor 24. For example, the terminal 26 includes a pair of crimping pieces, with which the terminal 26 is crimped to the second end portion 24b of the flexible conductor 24.

In addition, the second conductive path 30 includes a second tubular conductor 31, an insulating coating 32, flexible conductors 23 and 24, and terminals 25 and 26. As shown in FIGS. 4 and 6, the second conductive path 30 is parallel with the first conductive path 20. The second conductive path 30 is configured in a similar manner to the first conductive path 20, and, for example, the second tubular conductor 31 is a component having the same model number as the first tubular conductor 21. Similar names and reference numerals are given to the constituent components of the second conductive path 30 that are similar to the constituent components of the first conductive path 20, and a detailed description thereof is omitted.

As shown in FIGS. 3, 4, and 6, the cooling tube 40 is hollow. The cooling tube 40 is more flexible than the first tubular conductor 21 and the second tubular conductor 31. In other words, the first tubular conductor 21 and the second tubular conductor 31 are more rigid than the cooling tube 40. The cooling tube 40 includes a first section 41 that extends through the first tubular conductor 21, a second section 42 that extends through the second tubular conductor 31, and a turnback portion 43 that links the first section 41 and the second section 42.

As shown in FIG. 4, in the present embodiment, an outer circumferential surface 41a of the first section 41 is in contact with an inner circumferential surface 21c of the first tubular conductor 21. An outer circumferential surface 42a of the second section 42 is in contact with an inner circumferential surface 31c of the second tubular conductor 31. Note that an adhesive or a resin material such as a pressure-sensitive adhesive may be interposed between the outer circumferential surface 41a of the first section 41 and the inner circumferential surface 21c of the first tubular conductor 21. In addition, an adhesive or a resin material such as a pressure-sensitive adhesive may be interposed between the outer circumferential surface 42a of the second section 42 and the inner circumferential surface 31c of the second tubular conductor 31. A material that has excellent heat conductivity can be used as an interposing resin material. As shown in FIG. 6, the turnback portion 43 of the cooling tube 40 is provided on the first end portion 21a side of the first tubular conductor 21. The turnback portion 43 is formed to protrude from the first tubular conductor 21 and the second tubular conductor 31 to the outside, and be folded so as to link the first section 41 and the second section 42. The turnback portion 43 in the present embodiment extends through the flexible conductors 23. The material for the cooling tube 40 is a flexible resin material such as PP (polypropylene), PVC (polyvinyl chloride), or cross-linked PE (polyethylene resin).

A coolant 73 is supplied to the inside of the cooling tube 40. The coolant 73 may be a liquid such as water and an antifreeze solution, or a fluid such as a gas, or an air-liquid two-phase flow in which a gas and a liquid are mixed. The coolant 73 is supplied by a pump (not shown). The cooling tube 40 forms a part of a circulation path through which the coolant 73 is circulated. The circulation path includes the above-described pump and a heat dissipating portion, for example. The pump pressurizes and feeds the coolant 73 to the cooling tube 40. The coolant 73 supplied to the cooling tube 40 performs heat-exchange with the first tubular conductor 21 and the second tubular conductor 31 disposed outside of the cooling tube 40. The heat dissipating portion cools the coolant 73 by dissipating heat from the coolant 73, of which the temperature has risen as a result of heat exchange, to the outside. The cooled coolant 73 is pressurized and fed again to the cooling tube 40 by the pump. The cooling tube 40 constitutes a cooling portion for cooling the first tubular conductor 21 and the second tubular conductor 31 using the coolant 73 circulated in this manner.

As shown in FIGS. 3 and 4, the electromagnetic shield member 50 covers two conductive paths 11. The electromagnetic shield member 50 is a braided member formed by braiding metal strands into a tubular shape. The electromagnetic shield member 50 has shielding properties. Also, the electromagnetic shield member 50 is flexible. As shown in FIG. 3, one end of the electromagnetic shield member 50 is connected to the connector 71, and the other end of the electromagnetic shield member 50 is connected to the connector 72. Accordingly, the electromagnetic shield member 50 covers the entire length of the conductive paths 11 that transmit a high voltage. In this manner, the radiation of electromagnetic noise originating from the conductive paths 11 to the outside is suppressed.

The exterior member 60 covers the conductive paths 11. The above-described cooling tube 40 extends through the first tubular conductor 21 and the second tubular conductor 31 of the conductive paths 11. Accordingly, the exterior member 60 covers the conductive paths 11 and at least a portion of the cooling tube 40.

The exterior member 60 includes a tubular exterior member 61 (exterior tube), and grommets 62 and 63 respectively connected to a first end portion 61a and a second end portion 61b of the tubular exterior member 61.

The tubular exterior member 61 covers portions of the outer circumferences of the first tubular conductor 21 and the second tubular conductor 31 in the lengthwise direction, for example. The tubular exterior member 61 is formed in a tubular shape in which the two ends thereof in the lengthwise direction of the first tubular conductor 21 and the second tubular conductor 31 are open, for example. The tubular exterior member 61 surrounds the entirety of the outer circumferences of the first tubular conductor 21 and the second tubular conductor 31 in the circumferential direction, for example. The tubular exterior member 61 of the present embodiment is formed in a cylindrical shape. The tubular exterior member 61 has a bellows structure in which, for example, annular protruding portions and annular recessed portions are alternately arranged along the axis direction (lengthwise direction) thereof in which the central axial line of the tubular exterior member 61 extends. Examples of the material for the tubular exterior member 61 include a conductive resin material and a non-conductive resin material. Examples of the resin material include a synthetic resin such as polyolefin, polyamide, polyester, and ABS resin. The tubular exterior member 61 of the present embodiment is a corrugated tube made of a synthetic resin.

The grommet 62 is formed in a substantially tubular shape. The grommet 62 is made of rubber, for example. The grommet 62 spans between the connector 71 and the tubular exterior member 61. The grommet 62 is fastened and fixed to the outer surface of the connector 71 by a fastening band 64a so as to be in close contact therewith. Also, the grommet 62 is fastened and fixed to the outer side of the first end portion 61a of the tubular exterior member 61 by a fastening band 64b so as to be in close contact therewith. As shown in FIG. 3, the turnback portion 43 of the cooling tube 40 is disposed inside the grommet 62.

The grommet 63 is formed in a substantially tubular shape. The grommet 63 is made of rubber, for example. The grommet 63 spans between the connector 72 and the tubular exterior member 61. The grommet 63 is fastened and fixed to the outer surface of the connector 72 by a fastening band 65a so as to be in close contact therewith. Also, the grommet 63 is fastened and fixed to the outer side of the second end portion 61b of the tubular exterior member 61 by a fastening band 65b so as to be in close contact therewith. Through holes 63a extending through the grommet 63 are formed in the grommet 63. The through holes 63a bring the inside and the outside of the grommet 63 into communication.

In the present embodiment, the two through holes 63a are formed in the grommet 63, and the cooling tube 40 is passed through the through holes 63a. Specifically, as shown in FIG. 4, the cooling tube 40 includes an inlet portion 44 extending from the first section 41 and an outlet portion 45 extending from the second section 42, on the opposite side to the turnback portion 43. The through holes 63a come in close contact with the outer circumferential surfaces of the inlet portion 44 and the outlet portion 45 which are respectively passed through the through holes 63a. As shown in FIG. 3, the inlet portion 44 extends through the flexible conductor 24 and the electromagnetic shield member 50, and is led from the through hole 63a of the grommet 63 to the outside of the grommet 63. Similarly to the inlet portion 44, the outlet portion 45 extends through the flexible conductor 24 and the electromagnetic shield member 50, and is led out from the through hole 63a of the grommet 63 to the outside of the grommet 63. The inlet portion 44 constitutes an inlet for the coolant 73 in the cooling tube 40. The outlet portion 45 constitutes an outlet for the coolant 73 in the cooling tube 40. The inlet portion 44 and the outlet portion 45 are connected to the pump.

### Operation

Next, operation of the wire harness unit 10 of the present embodiment will be described.

The wire harness unit 10 includes the conductive paths 11 that conduct electricity between the in-vehicle devices M1 and M2, and the cooling tube 40 constituting the cooling portion that cools the conductive paths 11. The conductive paths 11 respectively include the first tubular conductor 21 and the second tubular conductor 31 that are conductive and hollow, and the cooling tube 40, which is separate from the first tubular conductor 21 and the second tubular conductor 31, allows the coolant 73 to flow therethrough. The first tubular conductor 21 and the second tubular conductor 31 are more rigid than the cooling tube 40. Also, the cooling tube 40 includes the first section 41 extending through the first tubular conductor 21, the second section 42 extending through the second tubular conductor 31, and the turnback portion 43 that links the first section 41 and the second section 42.

The coolant 73 is supplied to the cooling tube 40. At this time, the coolant 73 flows through the inlet portion 44, the first section 41, the turnback portion 43, the second section 42, and the outlet portion 45 of the cooling tube 40 in the stated order. The first tubular conductor 21 and the second tubular conductor 31 are cooled through heat exchange with the coolant 73 supplied to the cooling tube 40. In this manner, the first tubular conductor 21 and the second tubular conductor 31 can be cooled from the inside.

Compared to a braided wire formed by twisting together a plurality of metal strands having the same cross sectional area and a single core wire having a solid structure, the first tubular conductor 21 and the second tubular conductor 31 have a larger outer circumference. In other words, the first tubular conductor 21 and the second tubular conductor 31 have a larger area on the outer circumferential side compared to a braided wire and a single core wire. Accordingly, since heat can be dissipated outward from a larger area, heat dissipation properties can be improved.

The conductive paths 11 include the flexible conductors 23 and 24 respectively connected to the first tubular conductor 21 and the second tubular conductor 31. The flexible conductors 23 and 24 are more flexible than the first tubular conductor 21 and the second tubular conductor 31. Accordingly, dimensional tolerance of the conductive paths 11 can be absorbed. Also, when the vehicle V vibrates, positional deviation between the parts connected to two ends of the flexible conductors 23 and 24 due to the vibration can be absorbed. In the present embodiment, for example, positional deviation between the first tubular conductor 21 and the connectors 71 and 72, that is, between the first tubular conductor 21 and the in-vehicle devices M1 and M2 can be absorbed. Accordingly, loads applied to the connectors 71 and 72 and the terminals 25 and 26 can be reduced.

Also, as shown in FIG. 3, the length L1 of the first tubular conductor 21 and the second tubular conductor 31 is greater than the lengths L2 and L3 of the flexible conductors 23 and 24. The lengths L2 and L3 of the flexible conductors 23 and 24 are lengths indicating the range in which the conductive paths 11 can be bent utilizing the flexibility of the flexible conductors 23 and 24. In the present embodiment, the lengths L2 and L3 are the distance between the connector 71 and the first tubular conductor 21 and the second tubular conductor 31, and the distance between the connector 72 and the first tubular conductor 21 and the second tubular conductor 31, respectively. Accordingly, the sections of the first tubular conductor 21 and the second tubular conductor 31 through which the cooling tube 40 extends are long, that is, the section in which the cooling tube 40 and the first tubular conductor 21 and the second tubular conductor 31 are in contact with each other and where heat exchange takes place can be increased in length, thus making it possible to further cool the first tubular conductor 21 and the second tubular conductor 31. Note that the lengths L2 and L3 of the flexible conductors 23 and 24 can be equal to or different from each other.

The flexible conductors 23 and 24 of the present embodiment are braided members formed by braiding metal strands into a tubular shape. For this reason, the cooling tube 40 can be led out from the flexible conductors 23 and 24 at intermediate positions of the flexible conductors 23 and 24. In this manner, the cooling tube 40 can be easily led out to the outside of the wire harness unit 10, and constituent members for circulating the coolant 73 can be easily connected to the cooling tube 40.

The electromagnetic shield member 50 covers the two conductive paths 11. The electromagnetic shield member 50 is a braided member formed by braiding metal strands into a tubular shape. For this reason, radiation of the electromagnetic noise originating from the conductive paths 11 to the outside can be suppressed. Also, for this reason, the cooling tube 40 can be led out from the electromagnetic shield member 50 at intermediate positions of the electromagnetic shield member 50. Thus, the cooling tube 40 can be easily led out to the outside of the wire harness unit 10, and constituent members for circulating the coolant 73 can be easily connected to the cooling tube 40.

The wire harness unit 10 includes the exterior member 60 for covering at least a portion of the cooling tube 40 and the conductive paths 11. The exterior member 60 includes a tubular exterior member 61, and grommets 62 and 63 respectively connected to a first end portion 61a and a second end portion 61b of the tubular exterior member 61. The cooling tube 40 extends through the grommet 63. In this manner, since the cooling tube 40 extends through the grommet 63 so as to be led to the outside of the wire harness unit 10, degradation of the water blocking properties of the wire harness unit 10 can be suppressed.

As described above, according to the present embodiment, the following effects are achieved.

(1) As a result of the first section 41 of the cooling tube 40 extending through the first tubular conductor 21 and the second section 42 extending through the second tubular conductor 31, the coolant 73 can flow inside the first tubular conductor 21 and the second tubular conductor 31. For this reason, the first tubular conductor 21 and the second tubular conductor 31 can be cooled from the inside, making it possible to improve the cooling efficiency. Moreover, the cooling tube 40 includes the turnback portion 43 that links the first section 41 and the second section 42, and thus, for example, compared with a case where the cooling tube 40 does not include the turnback portion 43 and the cooling tube 40 is provided for each of the conductive paths 11, it is possible to reduce the number of inlets and outlets for the coolant 73, specifically, the number of inlet portions 44 and outlet portions 45 of the cooling tube 40. Thus, a connection structure for connection between the cooling tube 40 and the pump can be simplified. In addition, for example, compared with a case where the cooling tube 40 does not include the turnback portion 43 and is provided for each of the conductive paths 11, it is possible to reduce the number of cooling tubes 40 and the number of components.

(2) The plurality of conductive paths 11 include the first conductive path 20 and the second conductive path 30. The number of conductive paths included in the plurality of conductive paths 11 is an even number, and thus the inlet and the outlet for the coolant 73, specifically, the inlet portion 44 and the outlet portion 45 can be naturally positioned on the second end portion 21b side of the first tubular conductor 21, and the inlet and the outlet for the coolant can be easily positioned close to each other. That is to say, a situation is avoided where the positions of the inlet and the outlet for the coolant 73 are spaced far apart from each other when, for example, the number of conductive paths 11 is three, which is an odd number, and the cooling tube 40 further includes a third section extending through a third tubular conductor of a third conductive path, and a turnback portion that links the second section and the third section. Thus, for example, it is possible to easily set the positions of the inlet portion 44 and the outlet portion 45 of the cooling tube 40 close to each other, and to reduce a routing space and the like for connection to a pump, for example.

(3) The turnback portion 43 is disposed inside the grommet 62, and thus, for example, the turnback portion 43 can be easily housed. Even in a case where, for example, the turnback portion 43 is configured such that it cannot be sharply bent, and a large space is required, such a case can be easily addressed without increasing the entire size of the tubular exterior member 61. Moreover, for example, if the grommet 62 is shaped such that the size thereof increases toward a member that is connected thereto, the turnback portion 43 can be easily housed in a large space.

(4) The outer circumferential surface 41a of the first section 41, which is an outer circumferential surface of the cooling tube 40 through which the coolant 73 flows comes into contact with the inner circumferential surface 21c of the first tubular conductor 21, and the outer circumferential surface 42a of the second section 42 is in contact with the inner circumferential surfaces 31c of the second tubular conductor 31, and thus it is possible to further cool the first tubular conductor 21 and the second tubular conductor 31.

(5) As a result of the flexible conductors 23 and 24 being connected to the end portions of the first tubular conductor 21 and the second tubular conductor 31, dimensional tolerance of the conductive paths 11 can be absorbed. Further, this configuration is a counter measure against swinging that occurs while a vehicle is travelling. That is to say, when the vehicle V vibrates, positional deviation between the parts connected to two ends of the flexible conductors 23 and 24 due to the vibration can be absorbed. In the present embodiment, the positional deviation between the connector 71 and the first tubular conductor 21 and the second tubular conductor 31 and the positional deviation between the connector 72 and the first tubular conductor 21 and the second tubular conductor 31, that is, between the in-vehicle device M1 and the first tubular conductor 21 and the second tubular conductor 31 and between the in-vehicle device M2 and the first tubular conductor 21 and the second tubular conductor 31 can be absorbed. Accordingly, loads applied to the connectors 71 and 72 and the terminals 25 and 26 can be reduced.

(6) The first tubular conductor 21 and the second tubular conductor 31 are longer than the flexible conductors 23 and 24, and thus sections in which the first tubular conductor 21 and the second tubular conductor 31 are in contact with the cooling tube 40 are long, making it possible to further cool the first tubular conductor 21 and the second tubular conductor 31.

(7) The electromagnetic shield member 50 is a braided member formed by braiding metal strands into a tubular shape, and the cooling tube 40, specifically the inlet portion 44 and the outlet portion 45, extend through the braided member, and thus both the shielding properties for suppressing radiation of electromagnetic noise originating from the conductive paths 11 to the outside and an improvement in the ease of assembly of the cooling portion can be achieved.

(8) Since the cooling tube 40, specifically the inlet portion 44 and the outlet portion 45, extend through the grommet 63 so as to be led to the outside, degradation of the water blocking properties of the wire harness unit 10 can be suppressed.

### Variations

The present embodiment can be modified and implemented as follows. The present embodiment and the variations below may be implemented in combination with each other as long as no technical contradictions arise.
In the above embodiment, the number of conductive paths included in the plurality of conductive paths 11 is an even number, but there is no limitation thereto, and the number of conductive paths may be an odd number of three or more, or may be an even number of four or more. A configuration may be adopted in which, for example, the number of conductive paths 11 is three, and the cooling tube 40 further includes a third section extending through a third tubular conductor on a third conductive path, and a turnback portion that links the second section and the third section. Moreover, a configuration may also be adopted in which, for example, the number of conductive paths 11 is four, for example, and the cooling tube 40 further includes a third section extending through a third tubular conductor on a third conductive path, a turnback portion that links the second section and the third section, a fourth section extending through a fourth tubular conductor on a fourth conductive path, and a turnback portion that links the third section and the fourth section.
In the above embodiment, the turnback portion 43 is configured to be disposed inside the grommet 62, but there is no limitation thereto, and the turnback portion 43 may be configured to be disposed at another location such as inside the tubular exterior member 61.
In the above embodiment, the cooling tube 40 is led out from the grommet 63, that is, the cooling tube 40 is passed through grommet 63. However, the cooling tube 40 may be led out from the connector 72. By doing so, the first tubular conductor 21, the second tubular conductor 31, and the connector 72 can be cooled.
The electromagnetic shield member 50 of the above embodiment may be a piece of metal tape or the like. An insulation layer may be provided on the inner circumferential surface of the electromagnetic shield member 50.
Twisted wires formed by twisting a plurality of metal strands together may be used as the flexible conductors 23 and 24 of the above embodiment.
In contrast to the above embodiment, the tubular flexible conductors 23 and 24 do not need to cover the first tubular conductor 21 and the second tubular conductor 31. For example, the tubular flexible conductors 23 and 24 may be rounded into a rod-like shape so as to be electrically connected to the first tubular conductor 21 and the second tubular conductor 31. In this case, it is not necessary to lead out the cooling tube 40 that extends through the first tubular conductor 21 and the second tubular conductor 31, from the intermediate portions of the flexible conductors 23 and 24, thereby facilitating assembly.
In contrast to the above embodiment, a configuration is also possible in which, for example, the tubular flexible conductors 23 and 24 are formed in a sheet-like shape, and are thereby electrically connected to the first tubular conductor 21 and the second tubular conductor 31. The flexible conductors 23 and 24 may or may not be wrapped around the cooling tube 40 that extends through the first tubular conductor 21 and the second tubular conductor 31. If the flexible conductors 23 and 24 are wrapped around the cooling tube 40, the cooling tube 40 can be easily drawn out from a gap between the flexible conductors 23 and 24 overlaid in the manner of a sushi roll.
Although the above embodiment and the variations described that the shape of the flexible conductor 23 on the connector 71 side and the shape of the flexible conductor 24 on the connector 72 side are the same, their shapes may be different from each other.
The first tubular conductor 21 and the second tubular conductor 31 may have a length corresponding to the routing path corresponding to substantially the entire length of the wire harness unit 10 excluding the connectors 71 and 72 on the two end of the wire harness unit 10 and the lengths L2 and L3. The first tubular conductor 21 and the second tubular conductor 31 may be rigid to the extent that the length (for example, bending degree) and/or thickness of the first tubular conductor 21 and the second tubular conductor 31 does not change between immediately before and after the wire harness unit 10 is mounted in a vehicle.
As shown in FIGS. 2 to 4, the wire harness unit 10 according to a preferable example can include the first tubular conductor 21, the second tubular conductor 31, the cooling tube 40, the flexible conductors 23 and 24, and the electromagnetic shield member 50. The first tubular conductor 21 and the second tubular conductor 31 each may have a first opening end, a second opening end, and a pipe length defined by the first opening end and the second opening end. The first tubular conductor 21 and the second tubular conductor 31 may be disposed side by side over the entire lengths thereof. A configuration may also be adopted in which, for example, the first opening end of the first tubular conductor 21 and the first opening end of the second tubular conductor 31 are disposed side by side, and the second opening end of the second tubular conductor 31 and the second opening end of the second tubular conductor 31 are disposed side by side. The cooling tube 40 may have a tube length that is longer than the total of the pipe length of the first tubular conductor 21 and the pipe length of the second tubular conductor 31. The cooling tube 40 may have a first intermediate length portion that is housed in the first tubular conductor 21, and extends through the first tubular conductor 21 in the lengthwise direction, a second intermediate length portion that is housed in the second tubular conductor 31, and extends through the second tubular conductor 31 in the lengthwise direction, and a third intermediate length portion that is positioned between the first intermediate length portion and the second intermediate length portion, extends from the first pipe opening end of the first tubular conductor 21 and the first pipe opening end of the second tubular conductor 31 in the lengthwise direction, and is bent into a U-shape between the first pipe opening end of the first tubular conductor 21 and the first pipe opening end of the second tubular conductor 31. The U-shaped third intermediate length portion of the cooling tube 40 may extend, in a radial direction, through the flexible conductors 23 associated with the first tubular conductor 21 and the second tubular conductor 31, and be disposed inside the electromagnetic shield member 50. For example, the flexible conductor 23 associated with the first tubular conductor 21 may have a first lateral opening formed by partially unbraiding the braided member, and the flexible conductor 23 associated with the second tubular conductor 31 may have a second lateral opening formed by partially unbraiding the braided member. The first lateral opening and the second lateral opening may be adjacent to and face each other in a radial direction. The U-shaped third intermediate length portion of the cooling tube 40 may radially pass through the flexible conductors 23 respectively associated with the first tubular conductor 21 and the second tubular conductor 31, via the first and second lateral openings that face each other.
As in the illustrated example, the cooling tube 40 may be a single seamless continuous tube that integrally has the first, second, and third intermediate length portions. The cooling tube 40 can have two tube end portions that are not covered by the first tubular conductor 21 and the second tubular conductor 31. The two tube end portions of the cooling tube 40 may extend side by side in the same lengthwise direction via the second pipe opening end of the first tubular conductor 21 and the pipe opening end of the second tubular conductor 31, radially extend through the flexible conductors 24 respectively associated with the first tubular conductor 21 and the second tubular conductor 31, radially extend through the electromagnetic shield member 50 that covers the first tubular conductor 21 and the second tubular conductor 31, and extend side by side radially outward from the electromagnetic shield member 50. The two tube end portions of the cooling tube 40 may extend through the electromagnetic shield member 50 radially at a predetermined length position that is far from the first pipe opening ends of the first tubular conductor 21 and the second tubular conductor 31, and is close to the second pipe opening ends of the first tubular conductor 21 and the second tubular conductor 31.
As shown in FIG. 4, the wire harness unit 10 according to a preferable example may include the first tubular conductor 21, the second tubular conductor 31, and the cooling tube 40. The first tubular conductor 21 and the second tubular conductor 31 may have inner circumferential pipe surfaces having the same inner pipe diameter. The cooling tube 40 may have an outer circumferential tube surface having an outer tube diameter that matches or corresponds to the inner pipe diameters of the first tubular conductor 21 and the second tubular conductor 31. The inner circumferential pipe surface of the first tubular conductor 21 may be in contact with the outer circumferential tube surface of the cooling tube 40 over the pipe length of the first tubular conductor 21 such that the inner circumferential pipe surface can or cannot move relative to the outer circumferential tube surface of the cooling tube 40. The inner circumferential pipe surface of the second tubular conductor 31 may be in contact with the outer circumferential tube surface of the cooling tube 40 over the pipe length of the second tubular conductor 31 such that the inner circumferential pipe surface can or cannot move relative to the outer circumferential tube surface of the cooling tube 40. The outer circumferential tube surface of the cooling tube 40 may be in contact with the inner circumferential pipe surfaces of the first tubular conductor 21 and the second tubular conductor 31, under frictional resistance or adhesion.

1. A wire harness unit comprising:
a plurality of conductive paths for conducting electricity between in-vehicle devices; and
a cooling tube through which a coolant is able to flow for cooling the plurality of conductive paths, wherein:
the plurality of conductive paths include a first conductive path and a second conductive path parallel with the first conductive path,
the first conductive path includes a first tubular conductor that is conductive and hollow,
the second conductive path includes a second tubular conductor that is conductive and hollow,
the cooling tube is separate from the first tubular conductor and the second tubular conductor,
the first tubular conductor and the second tubular conductor are more rigid than the cooling tube, and
the cooling tube includes a first section extending through the first tubular conductor, a second section extending through the second tubular conductor, and a turnback portion that links the first section and the second section.

2. The wire harness unit according to claim 1,
wherein a number of conductive paths included in the plurality of conductive paths is an even number.

3. The wire harness unit according to claim 1, further comprising
an exterior cover for covering the conductive paths, wherein:
the exterior cover includes an exterior tube and a grommet that is connected to an end of the exterior tube, and
the turnback portion is disposed inside the grommet.

4. The wire harness unit according to claim 1,
wherein an outer circumferential surface of the cooling tube is in contact with an inner circumferential surface of the first tubular conductor and an inner circumferential surface of the second tubular conductor.

5. The wire harness unit according to claim 1, wherein:
the first conductive path and the second conductive path each include a flexible conductor and a terminal,
the flexible conductor includes a first end that is electrically connected to the first tubular conductor or the second tubular conductor, and a second end that is electrically connected to the terminal, and
the flexible conductor is more flexible than the first tubular conductor and the second tubular conductor.

6. The wire harness unit according to claim 5,
wherein each of the first tubular conductor and the second tubular conductor is longer than the flexible conductor.

7. The wire harness unit according to claim 1, further comprising
an electromagnetic shield for covering at least a portion of the cooling tube, the first tubular conductor, and the second tubular conductor,
the electromagnetic shield is a braided member formed by braiding metal strands, and
the cooling tube extends through the braided member.

8. The wire harness unit according to claim 1, further comprising
an exterior cover for covering the conductive paths, wherein:
the exterior cover includes an exterior tube and a grommet connected to an end of the exterior tube, and
the cooling tube extends through the grommet.
